(19) United States
(12) Patent Application Publication
(10) Pub. No.: US 2010/0089053 A1
(43) Pub. Date: Apr. 15, 2010

(54) HYBRID ELECTROMECHANICAL/HYDRO-MECHANICAL ACTUATION CONTROL SYSTEM

(75) Inventors: Casey Hanlon, Queen Creek, AZ (US); Dean Wilkens, Scottsdale, AZ (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/250,353

(22) Filed: Oct. 13, 2008

(51) Int. Cl. F15B 11/16

(52) U.S. Cl. 60/545; 60/581

(57) ABSTRACT

A hybrid actuation system includes one or more electromechanical actuators, one or more master hydraulic actuators, and a slave hydraulic actuator. Each electromechanical actuator is adapted to be controllably energized and is configured, upon being controllably energized, to supply a drive force. Each master hydraulic actuator is coupled to receive the drive force from an electromechanical actuator and is configured, upon receipt of the drive force, to at least selectively supply pressurized hydraulic fluid. The slave hydraulic actuator is in fluid communication with the master hydraulic actuator to receive pressurized hydraulic fluid therefrom. The slave hydraulic actuator is responsive to pressurized hydraulic fluid supplied from the master hydraulic actuator to move to a control position.

### TECHNICAL FIELD

The present invention relates to actuator controls and, more particularly, to an actuation system that is a hybrid of electromechanical actuation and hydraulic actuation technologies.

### BACKGROUND

Aircraft typically include a plurality of flight control surfaces that, when controllably positioned, guide the movement of the aircraft from one destination to another. The number and type of flight control surfaces included in an aircraft may vary depending, for example, on whether the aircraft is a fixed-wing or rotary-wing aircraft. For example, most fixed-wing aircraft typically include primary flight control surfaces, such as a pair of elevators, a rudder, and a pair of ailerons, to control aircraft movement in the pitch, yaw, and roll axes. Aircraft movement of rotary-wing aircraft in the pitch, yaw, and roll axes is typically controlled by via movement of the rotating aircraft rotors, and may additionally be controlled via movement of one or more flight control surfaces.

The positions of the aircraft flight control surfaces and/or rotors are typically controlled via a flight control system. The flight control system, in response to position commands that originate from either the flight crew or an aircraft autopilot, moves the aircraft flight control surfaces and/or rotors to the commanded positions. In most instances, this movement is effected via actuators that are coupled to the flight control surfaces. Typically, the position commands that originate from the flight crew are supplied via one or more inceptors. For example, many fixed-wing aircraft include a plurality of inceptors, such as yokes or side sticks and rudder pedals, one set each for the pilot and for the co-pilot, and many rotary-wing aircraft include one or more of a cyclic, a collective, and rudder pedals.

In many aircraft, including both fixed-wing aircraft and rotary-wing aircraft, the flight control system may be a hydro-mechanical system, which may include relatively complex hydraulic plumbing and various hydraulic actuators. More recently, all or portions of these hydro-mechanical flight control systems are being retrofitted or replaced with electromechanical systems. No matter the particular type of system that is implemented (e.g., hydro-mechanical or electromechanical), the flight control system may need to be designed to withstand postulated, though unlikely, component inoperability. For example, the flight control system may need to withstand the postulated occurrence of an actuator becoming inoperable. At the same time, these systems should be designed to prevent a very highly unlikely, yet postulated, common-mode failure that could result in loss of control. Designing flight control systems to meet such design standards can be relatively costly and complex when trying to implement an electromechanical type system.

Hence, there is a need for an electromechanically-based fly-by-wire flight control system that can withstand postulated, though unlikely, component inoperability and highly unlikely, yet postulated, common-mode failures, and that can be implemented at a cost that is relatively less costly and/or relatively less complex than presently known systems. The present invention addresses at least this need.

### BRIEF SUMMARY

In one embodiment, and by way of example only, an actuation system includes an electromechanical actuator, a master hydraulic actuator, and a slave hydraulic actuator. The electromechanical actuator is adapted to be controllably energized and is configured, upon being controllably energized, to supply a drive force. The master hydraulic actuator is coupled to receive the drive force from the electromechanical actuator and is configured, upon receipt of the drive force, to at least selectively supply pressurized hydraulic fluid. The slave hydraulic actuator is in fluid communication with the master hydraulic actuator to receive pressurized hydraulic fluid therefrom. The slave hydraulic actuator is responsive to pressurized hydraulic fluid supplied from the master hydraulic actuator to move to a control position.

In another embodiment, an actuation system includes a plurality of electromechanical actuators, a plurality of master hydraulic actuators, and a slave hydraulic actuator. Each electromechanical actuator is adapted to be controllably energized and is configured, upon being controllably energized, to supply a drive force. Each master hydraulic actuator is coupled to receive the drive force from one of the electromechanical actuators and is configured, upon receipt thereof, to at least selectively supply pressurized hydraulic fluid. The slave hydraulic actuator is in fluid communication with each of the master hydraulic actuators to receive pressurized hydraulic fluid therefrom. The slave hydraulic actuator is responsive to pressurized hydraulic fluid supplied from at least one of the master hydraulic actuators to move to a control position.

In yet another embodiment, an actuation system includes a plurality of electromechanical actuators, a plurality of master hydraulic actuators, a first manifold, a second manifold, a plurality of first supply/return conduits, a plurality of second supply/return conduits, a slave hydraulic actuator, and a control. Each electromechanical actuator is adapted to be controllably energized and is configured, upon being controllably energized, to supply a drive force. Each master hydraulic actuator is coupled to receive the drive force from one of the electromechanical actuators and is configured, upon receipt thereof, to at least selectively supply pressurized hydraulic fluid. The first and second manifolds each have a plurality of master hydraulic ports and a slave hydraulic port. Each first supply/return conduit is coupled to, and provides fluid communication between, one of the master hydraulic actuators and one of the first manifold master hydraulic ports. Each second supply/return conduit is fluidly isolated from the first supply/return conduits, and each is coupled to, and provides fluid communication between, one of the master hydraulic actuators and one of the second manifold master hydraulic ports. The slave hydraulic actuator is in fluid communication with the slave hydraulic port and each of the second supply/return conduits. The slave hydraulic actuator is responsive to pressurized hydraulic fluid supplied from at least one of the master hydraulic actuators to move to a control position. The control is in operable communication with, and is configured to selectively and controllably energize, each of the electromechanical actuators.

Other desirable features and characteristics of the present invention will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein

FIG. 1 depicts a functional schematic representation of an exemplary rotary-wing aircraft;

FIG. 2 depicts a functional schematic representation of an actuation system that may be implemented in the aircraft of FIG. 1; and

FIG. 3 depicts a functional schematic representation of at least a portion of a particular implementation of the actuation system of FIG. 2.

### DETAILED DESCRIPTION

The following detailed description is merely exemplary in nature and is not intended to limit the invention or the application and uses of the invention. Furthermore, there is no intention to be bound by any theory presented in the preceding background or the following detailed description. In this regard, although the present invention is depicted and described in the context of a single main rotor helicopter, the present invention is not limited to this type of aircraft, to aircraft in general, or to vehicular environments. Indeed, the invention could be implemented in various other aircraft including, but not limited to, various fixed-wing aircraft, multi-rotor rotary-wing aircraft, NOTAR (no tail rotor) rotary-wing aircraft, tip jet rotor rotary-wing aircraft, and contra-rotating rotary-wing aircraft. The invention could also be implemented in various other vehicular and non-vehicular environments.

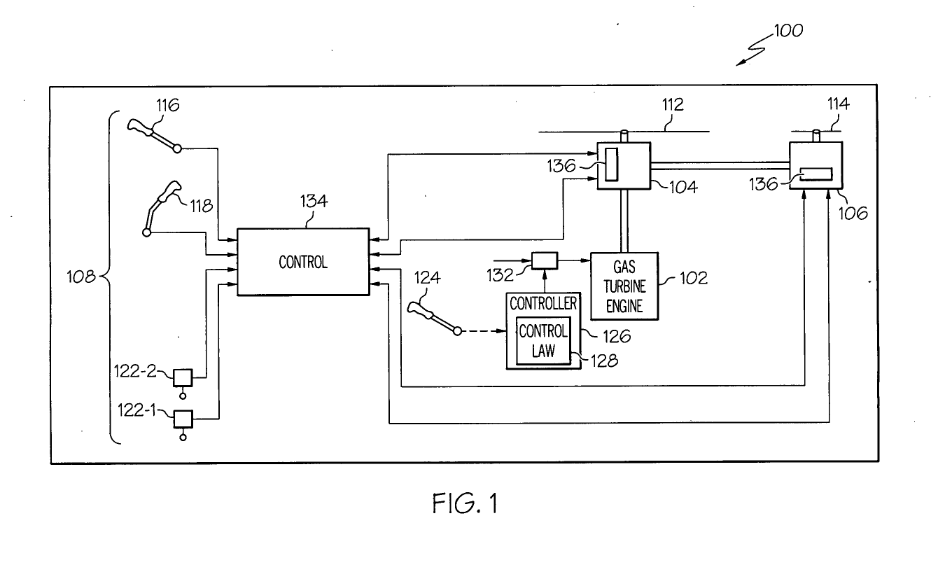

Referring now to FIG. 1, a functional schematic representation of an exemplary rotary-wing aircraft is depicted. The depicted rotary-wing aircraft is a helicopter 100 that includes a gas turbine engine 102, a main rotor 104, a tail rotor 106, and a plurality of flight control inceptors 108. The gas turbine engine 102, when operating, generates torque, which is supplied, via suitable interconnecting gears and drive trains, to the main rotor 104 and the tail rotor 106.

The main rotor 104 includes a plurality of main rotor blades 112 and, when rotated by the gas turbine engine 102, generates vertical lift for the aircraft 100. The tail rotor 106 includes a plurality of rotor blades 114 and, when rotated by the gas turbine engine 102, generates a horizontal lift for the aircraft 100. The horizontal lift, as is generally known, is used to counteract the torque effect resulting from the rotation of main rotor 104, which causes the helicopter 100 to want to turn in a direction opposite to rotational direction of the main rotor 104.

The flight control inceptors 108 include three separate devices—a collective 116, a cyclic 118, and anti-torque pedals 122. The collective 116 is used to control the altitude of the helicopter 100 by simultaneously changing the pitch angle of all the main rotor blades 112 independently of their position. Therefore, if a collective input is made, the pitch angle of all of the main rotor blades 112 change simultaneously and equally, resulting in the helicopter 100 either increasing or decreasing in altitude.

The cyclic 118 is used to control the attitude and airspeed of the helicopter 100 by controlling the pitch of the main rotor blades 112 cyclically. More specifically, the relative pitch (or feathering angle) of each of the main rotor blades 112 will vary as they rotate. The variation in relative pitch has the effect of varying the angle of attack of, and thus the lift generated by, each main rotor blade 112 as it rotates. Hence, if the cyclic 118 is moved forward or backward, the rotor disk (to which the main rotor blades 112 are coupled) tilts forward or backward, respectively, and thrust is produced in the forward direction or backward direction, respectively. Similarly, if the cyclic 118 is moved to the right or to the left, the rotor disk tilts to the right or left, respectively, and thrust is produced in the right direction or left direction, respectively.

The anti-torque pedals 122 (e.g., 122-1, 122-1) are used to control the yaw of the helicopter 100 (i.e., the direction in which it is pointed) by controlling the pitch of the tail rotor blades 114, thereby altering the amount of horizontal thrust produced by the tail rotor 106. More specifically, pressing the left pedal 122-1 or the right pedal 122-2 changes the pitch of the tail rotor blades 114, thereby increasing the horizontal thrust produced by the tail rotor 106 in the left or right direction, respectively. As a result, the helicopter 100 will yaw in the direction of the pressed pedal 122.

The aircraft additionally includes a throttle 124, which is used to control the speed of the gas turbine engine 102. In the depicted embodiment the throttle 124 is shown as a separate power lever. It will be appreciated, however, that in some embodiments the throttle 124 may be implemented as a twist grip device that is disposed on another one of thus controls such as, for example, the collective 116. No matter how it is specifically configured, the throttle 124 supplies a suitable input signal to an engine controller 126. The engine controller 126 implements an engine control law 128 to control a suitable fuel flow control device 132, to control and regulate fuel flow to, and thus the speed of, the engine 102.

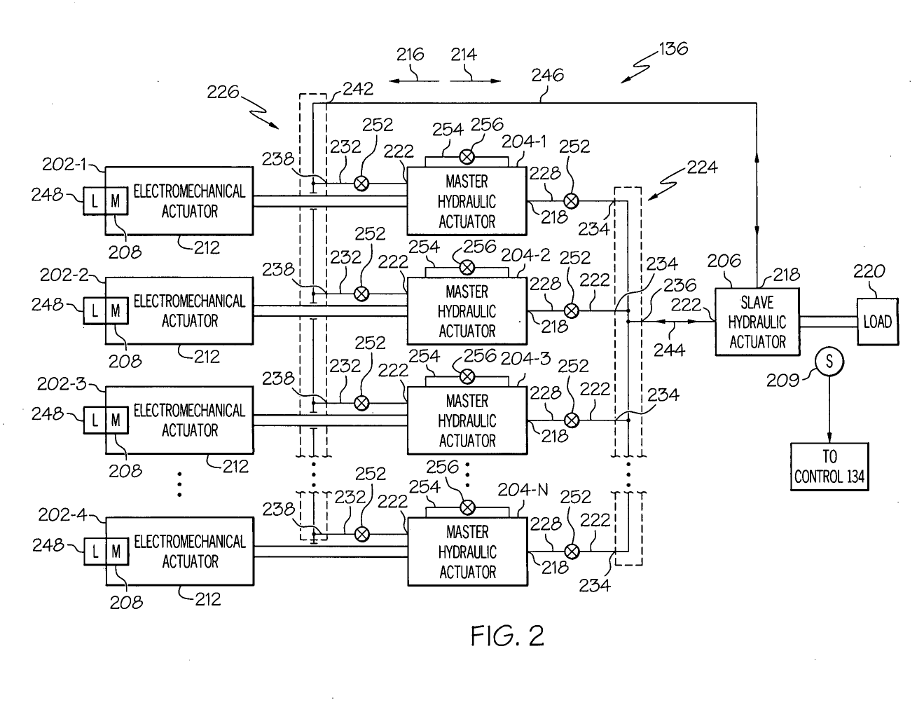

The inceptors 116-122 each supply, to a control 134, signals representative of a commanded maneuver. The control 134, in response to the supplied signals, controllably energizes one or more actuation systems 136 from a non-illustrated power source, to cause the aircraft 100 to implement the commanded maneuver. The actuation systems 136 are each hybrid actuation systems; that is, each actuation system 136 includes both electromechanical actuators and hydraulic actuators. In the depicted embodiment, the helicopter 100 includes two actuation systems 136. It will be appreciated, however, that this is merely exemplary, and that the helicopter 100 could include more or less than this number of actuation systems 136. Moreover, various other aircraft, or other vehicles, could include more or less than this number of actuation systems 136, as needed or desired. A functional schematic representation of an exemplary embodiment of a hybrid actuation system 136 is depicted in FIG. 2, and will now be described.

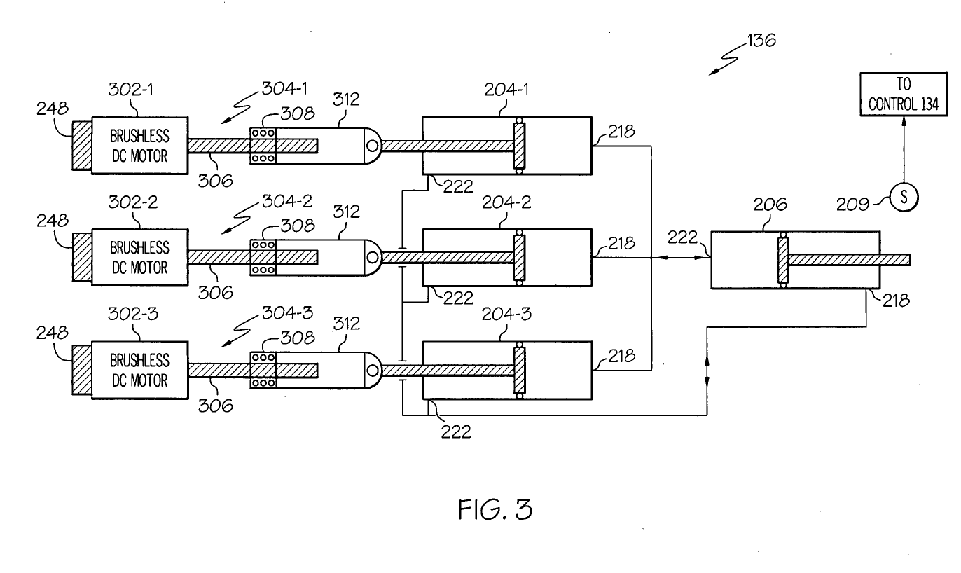

The actuation system 136 includes a plurality of electromechanical actuators 202 (e.g., 202-1, 202-2, 202-3, . . . 202-N), a plurality of master hydraulic actuators 204 (e.g., 204-1, 204-2, 204-3, . . . 204-N), and a slave hydraulic actuator 206. Each electromechanical actuator 202 is, as noted above, controllably energized, by the control 134, from a non-illustrated power source. The electromechanical actuators 202 each include a motor 208 and an actuator 212, and are each configured, upon being controllably energized, to supply a drive force to one of the master hydraulic actuators 204. Although the actuation system 136 preferably includes a plurality of electromechanical actuators 202, it will be appreciated that the actuation system 136 may, in some embodiments, be implemented with only a single electromechanical actuator 202. In a particular preferred embodiment, which is depicted in FIG. 3, the actuation system 136 includes three electromechanical actuators 202 (e.g., 202-1, 202-2, 202-3).

In addition to being implemented in varying numbers, the electromechanical actuators 202 may be implemented using any one of numerous types of motors 208 and actuators 212. For example, the motors 208 may be implemented using brushed or brushless DC motors, various types of AC motors, a voice coil, a proportional solenoid, various types of linear motors, or various piezoelectric devices. The actuators 212 may be implemented using any one of numerous suitable linear actuators, such as ball screw, roller screw, and acme screw actuators. The actuators 212 may also be implemented using any one of numerous suitable rotary actuators that are configured to provide a linear output via, for example, a bell crank and mechanical link. It will be appreciated that the electromechanical actuators 202 may additionally include a gearbox between the motor 208 and the actuator 212, if need or desired.

In the embodiment depicted in FIG. 3, it is seen that the electromechanical actuators 202 are implemented using brushless DC motors 302 and ball screw actuators 304. The ball screw actuators 304 each include a ball screw 306 and a ball nut 308. In the depicted configuration, the motors 302, when controllably energized, rotate the associated ball screw 306. The ball nuts 308 are each anti-rotationally mounted on a ball screw 306. Thus, when a ball screw 306 is rotated, the ball nut 308 that is mounted thereon translates, and supplies a drive force to an associated master hydraulic actuator 204, in either a first direction 214 or a second direction 216. In the depicted embodiment an extension tube 312 is coupled between each ball nut 308 and its associated master hydraulic actuator 204. Thus, the drive force is supplied to each master hydraulic actuator 204 via one of the extension tubes 312. It will be appreciated that in some embodiments the extension tubes 312 may be eliminated.

Returning to FIG. 2, it is seen that each master hydraulic actuator 204 is connected to, or otherwise coupled to receive the drive force from, one of the electromechanical actuators 202. Because a master hydraulic actuator 204 is coupled to receive the drive force from one of the electromechanical actuators 202, it will be appreciated that the actuation system 136 may, in those embodiments that include only a single electromechanical actuator 202, also be implemented with only a single master hydraulic actuator 204. In the particular preferred embodiment depicted in FIG. 3, the actuation system 136 includes three electromechanical actuators 202 (e.g., 202-1, 202-2, 202-3), and thus also includes three master hydraulic actuators 204 (e.g., 204-1, 204-2, 204-3).

Returning again to FIG. 2, no matter the specific number of master hydraulic actuators 204 that are used, each is configured, upon receipt of the drive force from its associated electromechanical actuator 202, to at least selectively supply pressurized hydraulic fluid. The slave hydraulic actuator 206 is in fluid communication with each of the master hydraulic actuators 204, and is responsive to pressurized hydraulic fluid supplied from one or more of the master hydraulic actuators 204 to move to a control position. One or more position sensors 209 (only one depicted) are provided to sense the position of the slave hydraulic actuator and/or load, and supply a position feedback signal representative thereof to, for example, the control 134.

To implement the above-described functionality it is seen that each master hydraulic actuator 204 and the slave hydraulic actuator 206 include a first inlet/outlet port 218 and a second inlet/outlet port 222. The first inlet/outlet port 218 of each master hydraulic actuator 204 is in fluid communication with the second inlet/outlet port 222 of the slave hydraulic actuator 206, and the second inlet/outlet port 222 of each master hydraulic actuator 204 is in fluid communication with the first inlet/outlet port 218 of the slave hydraulic actuator 206. In this regard, it may thus be appreciated that when an electromechanical actuator 202 supplies a drive force to its associated master hydraulic actuator 204 in the first direction 214, the associated master hydraulic actuator 204 supplies pressurized hydraulic fluid, via its first inlet/outlet port 218, to the slave hydraulic actuator 206, via its second inlet/outlet port 222. The slave hydraulic actuator 206, upon receipt of the pressurized hydraulic fluid, also moves a load 220 (e.g., rotor blades, a flight control surface, etc.) in the first direction 214 toward a control position, and discharges hydraulic fluid from its first inlet/outlet port 218, which is supplied to the appropriate master hydraulic actuator 204, via its second inlet/outlet port 222. Conversely, when an electromechanical actuator 202 supplies a drive force to its associated master hydraulic actuator 204 in the second direction 216, the associated master hydraulic actuator 204 supplies pressurized hydraulic fluid, via its second inlet/outlet port 222, to the slave hydraulic actuator 206, via its first inlet/outlet port 222. The slave hydraulic actuator 206, upon receipt of the pressurized hydraulic fluid, also moves the load 220 in the second direction 216 toward a control position, and discharges hydraulic fluid from its second inlet/outlet port 222, which is supplied to the appropriate master hydraulic actuator 204, via its first inlet/outlet port 222.

The fluid communication between the master hydraulic actuators 204 and the slave hydraulic actuator 206 may be variously implemented, but in the depicted embodiment the actuation system 136 additionally includes a first manifold 224, a second manifold 226, a plurality of first supply/return conduits 228, and a plurality of second supply/return conduits 232. The first manifold 224 includes a plurality of master hydraulic ports 234 in fluid communication with a slave hydraulic port 236. Similarly, the second manifold 226 includes a plurality of master hydraulic ports 238 in fluid communication with a slave hydraulic port 242. Each first supply/return conduit 228 is coupled to, and provides fluid communication between, one of the master hydraulic actuators 204 (e.g., via a first inlet/outlet port 218) and one of the first manifold master hydraulic ports 234. Each of the second supply/return conduits 232 is fluidly isolated from the first supply/return conduits 228, and each is coupled to, and provides fluid communication between, one of the master hydraulic actuators 204 (e.g., via a second inlet/outlet port 222) and one of the second manifold master hydraulic ports 238. As FIG. 2 also depicts, the first manifold slave hydraulic port 236 and the second manifold slave hydraulic port 242 are both in fluid communication with the slave hydraulic actuator 204. In particular, the first manifold slave hydraulic port 236 is in fluid communication with the slave hydraulic actuator second inlet/outlet port 222 via, for example, a third supply/return conduit 244, and the second manifold slave hydraulic port 242 is in fluid communication with the slave hydraulic actuator first inlet/outlet port 218 via, for example, a fourth supply/return conduit 246.

As with the electromechanical actuators 202, the master hydraulic actuators 204 and the slave hydraulic actuator 206 may be implemented using any one of numerous types of hydraulic actuators. For example, the master hydraulic actuators 204 and the slave hydraulic actuator 206 may be implemented as linear piston-in-cylinder actuators or bellows-type actuators, just to name a few. It will additionally be appreciated that the master hydraulic actuators 204 and the slave hydraulic actuator 206 may be implemented using the same or different types of hydraulic actuators, if needed or desired. In the embodiment depicted in FIG. 3, it is seen that the master and slave hydraulic actuators 204, 206 are implemented using the same type of linear piston-in-cylinder hydraulic actuators.

Returning once again to FIGS. 1 and 2, it is noted that the control 134 and actuation systems 136 may be configured to controllably energize all of the electromechanical actuators 202 simultaneously, to controllably energize only a single electromechanical actuator 202 at a time, or to controllably energize more than one but less than all of the electromechanical actuators 202 simultaneously. In each of these instantiations, if one or more of the electromechanical actuators 202 is non-operational, either by system configuration or due to some type of fault, the non-operational electromechanical actuators 202 and/or associated master hydraulic actuators 204 are isolated. It is noted that in a particular preferred embodiment, all of the electromechanical actuators 202 are simultaneously energized.

As may be appreciated, the above-mentioned isolation of electromechanical actuators 202 and/or master hydraulic actuators 204 may be variously implemented. For example, and as FIG. 2 depicts, the actuation system 136 may additionally include a plurality of locks (or brake) 248. Each lock 248, if included, is coupled to one of the electromechanical actuators 202 and is movable between a lock position and an unlock position. In the lock position the lock 248 prevents its associated electromechanical actuator 202 from supplying a drive force, and in the unlock position the lock 248 does not prevent its associated electromechanical actuator 202 from supplying a drive force. Though the configuration of the locks 248 may vary, in a particular preferred embodiment each lock 248 is selectively energized and de-energized, preferably via the control 134, and is configured such that when it is de-energized it is in the lock position and when it is energized it moves to the unlock position.

In addition to or instead of the locks 248, the actuation system 136 may include one or more isolation valves 252 and/or bypass lines 254 and associated valves 256. More specifically, one or more isolation valves 252 may be disposed between each of the master hydraulic actuators 204 and the slave hydraulic actuator 206. That is, an isolation valve 252 may be disposed between each master hydraulic actuator first inlet/outlet port 218 and the slave actuator second inlet/outlet port 222, or between each master hydraulic actuator second inlet/outlet port 222 and the slave actuator first inlet/outlet port 218, or both (as depicted in FIG. 2). In each instantiation, the isolation valves 252 are movable between an open position and a closed position. When the isolation valve(s) 252 associated with a master hydraulic actuator 204 is (are both) in the open position, the slave hydraulic actuator 206 is fluidly coupled to that master hydraulic actuator 204, and is thus responsive to pressurized hydraulic fluid supplied from that master hydraulic actuator 204. Conversely, when the (one or both) isolation valve(s) 252 associated with a master hydraulic actuator 204 is (are) in the closed position, the slave hydraulic actuator 204 is at least partially fluidly isolated from that master hydraulic actuator 204, and is thus not responsive to pressurized hydraulic fluid supplied from that master hydraulic actuator 204.

If, as FIG. 2 depicts, the actuation system 136 includes bypass lines 254 and associated valves 256, a bypass line 254 is coupled to each of the master hydraulic actuator 204, and a bypass valve 256 is mounted on each bypass line 254. Preferably, one end of the each bypass line 254 is in fluid communication with its associated master hydraulic actuator first inlet/outlet port 218, and the other end of each bypass line is in fluid communication with its associated master hydraulic actuator second inlet/outlet port 222. Moreover, each bypass valve 256 is preferably movable between a closed position and an open position. It may thus be appreciated that when a bypass valve 256 is in the closed position its associated master hydraulic actuator 204 is responsive to a drive force from the associated electromechanical actuator 202 to supply pressurized hydraulic fluid to the slave hydraulic actuator 206. Conversely, when a bypass valve 256 is in the open position its associated master hydraulic actuator 204 is not responsive to a drive force from the associated electromechanical actuator 202 to supply pressurized hydraulic fluid to the slave hydraulic actuator 206.

It will be appreciated that the isolation valves 252 and/or bypass valves 256 may be implemented using any one of numerous types of suitable valves. It will additionally be appreciated that these valves 252, 256 may be operated either manually or via an actuator. Preferably, the valves 252, 256, when included, are operated via suitable actuators that are controlled via, for example, the control 134. Non-limiting examples of suitable actuators include solenoid actuators and torque motor actuators.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An actuation system, comprising:
an electromechanical actuator adapted to be controllably energized and configured, upon being controllably energized, to supply a drive force;
a master hydraulic actuator coupled to receive the drive force from the electromechanical actuator and configured, upon receipt of the drive force, to at least selectively supply pressurized hydraulic fluid; and
a slave hydraulic actuator in fluid communication with the master hydraulic actuator to receive pressurized hydraulic fluid therefrom, the slave hydraulic actuator responsive to pressurized hydraulic fluid supplied from the master hydraulic actuator to move to a control position.

2. The system of claim 1, further comprising:
a second electromechanical actuator adapted to be controllably energized and configured, upon being controllably energized, to supply a drive force; and
a second master hydraulic actuator coupled to receive the drive force from the second electromechanical actuator and configured, upon receipt thereof, to at least selectively supply pressurized hydraulic fluid.

3. The system of claim 2, wherein the slave hydraulic actuator is further in fluid communication with the second master hydraulic actuator to receive the pressurized hydraulic fluid selectively supplied therefrom, the slave hydraulic actuator responsive to pressurized hydraulic fluid supplied from the second master hydraulic actuator to move to the control position.

4. The system of claim 2, further comprising:
a third electromechanical actuator adapted to be controllably energized and configured, upon being controllably energized, to supply a drive force; and
a third master hydraulic actuator coupled to receive the drive force from the second electromechanical actuator and configured, upon receipt thereof, to at least selectively supply pressurized hydraulic fluid.

5. The system of claim 4, wherein the slave hydraulic actuator is further in fluid communication with the third master hydraulic actuator to receive the pressurized hydraulic fluid selectively supplied therefrom, the slave hydraulic actuator further responsive to pressurized hydraulic fluid supplied from the third master hydraulic actuator to move to the control position.

6. The system of claim 1, further comprising:
a lock coupled to the electromechanical actuator and movable between a lock position, in which the lock prevents the electromechanical actuator from supplying the drive force, and an unlock position, in which the lock does not prevent the electromechanical actuator from supplying the drive force.

7. The system of claim 6, wherein:
the lock is adapted to be selectively energized and deenergized; and
the lock is configured such that it is energized to move it to the unlock position.

8. The system of claim 1, further comprising:
an bypass line coupled to the master hydraulic actuator; and
a bypass valve mounted on the bypass line and movable between a closed position, in which the master hydraulic actuator is responsive to the drive force from the electromechanical actuator to supply pressurized hydraulic fluid to the slave hydraulic actuator, and an open position, in which the master hydraulic actuator is not responsive to the drive force from the electromechanical actuator to supply pressurized hydraulic fluid to the slave hydraulic actuator.

9. The system of claim 1, further comprising:
an isolation valve disposed between the master hydraulic actuator and the slave hydraulic actuator, the isolation valve movable between an open position, in which the slave hydraulic actuator is responsive to pressurized hydraulic fluid supplied from the master hydraulic actuator, and a closed position, in which the slave hydraulic actuator is not responsive to pressurized hydraulic fluid supplied from the master hydraulic actuator.

10. The system of claim 9, further comprising:
a first supply/return conduit coupled to, and providing fluid communication between, the master hydraulic actuator and the slave hydraulic actuator;
a second supply/return conduit fluidly isolated from the first supply/return conduit and coupled to, and providing fluid communication between, the master hydraulic actuator and the slave hydraulic actuator.

11. The system of claim 10, wherein the isolation valve is mounted on one of the first supply/return conduit and the second supply/return conduit.

12. The system of claim 1, further comprising:
a control in operable communication with, and configured to controllably energize, the electromechanical actuator.

13. An actuation system, comprising:
a plurality of electromechanical actuators, each electromechanical actuator adapted to be controllably energized and configured, upon being controllably energized, to supply a drive force;
a plurality of master hydraulic actuators, each master hydraulic actuator coupled to receive the drive force from one of the electromechanical actuators and configured, upon receipt thereof, to at least selectively supply pressurized hydraulic fluid; and
a slave hydraulic actuator in fluid communication with each of the master hydraulic actuators to receive pressurized hydraulic fluid therefrom, the slave hydraulic actuator responsive to pressurized hydraulic fluid supplied from at least one of the master hydraulic actuators to move to a control position.

14. The system of claim 13, further comprising:
a plurality of locks, each lock coupled to one of the electromechanical actuators and movable between a lock position, in which the lock prevents one of the electromechanical actuators from supplying the drive force, and an unlock position, in which the lock does not prevent one of the electromechanical actuators from supplying the drive force.

15. The system of claim 14, wherein:
each lock is adapted to be selectively energized and deenergized; and
each lock is configured such that it is energized to move it to the unlock position.

16. The system of claim 13, further comprising:
a plurality of bypass lines, each bypass line coupled to one of the master hydraulic actuators; and
a plurality of bypass valves, each bypass valve mounted on one of the bypass lines and movable between a closed position, in which the master hydraulic actuator to which the bypass line is coupled is responsive to the drive force from the electromechanical actuator to supply pressurized hydraulic fluid to the slave hydraulic actuator, and an open position, in which the master hydraulic actuator to which the bypass line is coupled is not responsive to the drive force from the electromechanical actuator to supply pressurized hydraulic fluid to the slave hydraulic actuator.

17. The system of claim 13, further comprising:
a plurality of isolation valves, each isolation valve associated with one of the master hydraulic actuators and disposed between its associated master hydraulic actuator and the slave hydraulic actuator, each isolation valve movable between an open position, in which the slave hydraulic actuator is responsive to pressurized hydraulic fluid supplied from the master hydraulic actuator with which the isolation valve is associated, and a closed position, in which the slave hydraulic actuator is not responsive to pressurized hydraulic fluid supplied from the master hydraulic actuator with which the isolation valve is associated.

18. The system of claim 17, further comprising:
a first manifold having a plurality of master hydraulic ports and a slave hydraulic port, the slave hydraulic port in fluid communication with the slave hydraulic actuator;
a plurality of first supply/return conduits, each first supply/return conduit coupled to, and providing fluid communication between, one of the master hydraulic actuators and one of the first manifold master hydraulic ports;
a second manifold having a plurality of master hydraulic ports and a slave hydraulic port, the slave hydraulic port in fluid communication with the slave hydraulic actuator;
a plurality of second supply/return conduits, each second supply/return conduit fluidly isolated from the first supply/return conduits and coupled to, and providing fluid communication between, one of the master hydraulic actuators and one of the second manifold master hydraulic ports.

19. The system of claim 13, further comprising:
a control in operable communication with, and configured to selectively and controllably energize, each of the electromechanical actuators.

20. An actuation system, comprising:
a plurality of electromechanical actuators, each electromechanical actuator adapted to be controllably energized and configured, upon being controllably energized, to supply a drive force;
a plurality of master hydraulic actuators, each master hydraulic actuator coupled to receive the drive force from one of the electromechanical actuators and configured, upon receipt thereof, to at least selectively supply pressurized hydraulic fluid; and
a first manifold having a plurality of master hydraulic ports and a slave hydraulic port;
a second manifold having a plurality of master hydraulic ports and a slave hydraulic port;
a plurality of first supply/return conduits, each first supply/return conduit coupled to, and providing fluid communication between, one of the master hydraulic actuators and one of the first manifold master hydraulic ports;
a plurality of second supply/return conduits, each second supply/return conduit fluidly isolated from the first supply/return conduits and coupled to, and providing fluid communication between, one of the master hydraulic actuators and one of the second manifold master hydraulic ports;
a slave hydraulic actuator in fluid communication with the first manifold slave hydraulic port and the second manifold slave hydraulic port, the slave hydraulic actuator responsive to pressurized hydraulic fluid supplied from at least one of the master hydraulic actuators to move to a control position; and
a control in operable communication with, and configured to selectively and controllably energize, each of the electromechanical actuators.
